(19) United States
(12) Patent Application Publication
(10) Pub. No.: US 2007/0236754 A1
(43) Pub. Date: Oct. 11, 2007

(54) IMAGE FORMING APPARATUS AND RESIST ADJUSTING METHOD THEREOF

(76) Inventors: Kazuya TASHIRO, Kanagawa (JP); Masanori Tanaka, Kanagawa (JP); Yutaka Itoh, Kanagawa (JP); Hiroyuki Negishi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/695,280

(22) Filed: Apr. 2, 2007

(30) Foreign Application Priority Data
Apr. 10, 2006 (JP) 2006-107858

(51) Int. Cl. H04N 1/04

(52) U.S. Cl. 358/486

(57) ABSTRACT

A system controller includes an optical sensor that is arranged on a carriage and detects a tip and an edge of recording paper. The system controller moves, according to a detection signal, the carriage in a main scanning direction and the recording paper in a sub-scanning direction at predetermined timing to form an image on the recording paper. After detection of the tip of the recording paper before printing, the system controller moves the carriage in the main scanning direction until the optical sensor detects at least one edge of the recording paper to specify the position of the recording paper. Based on the specified position, the system controller adjusts a position on the recording paper where the image is to be formed.

### CROSS-REFERENCE TO RELATED APPLICATIONS

The present document incorporates by reference the entire contents of Japanese priority document, 2006-107858 filed in Japan on Apr. 10, 2006.

### BACKGROUND OF THE INVENTION

1. Field of the Invention

The present invention relates to an image forming apparatus and a resist adjusting method thereof.

2. Description of the Related Art

In a commonly used inkjet recording device, a nozzle which discharges ink is alternatively moved (scanned) in a main scanning direction of a head that is arranged in a sub-scanning direction and in the sub-scanning direction of paper to form an image. In a commonly known method that is used in the inkjet recording device to correct (resist adjustment) misalignment of a printing start position, a pattern for resist adjustment is output and based on the misalignment of the output pattern, the printing start position is manually adjusted to output the accurate printing start position.

For example, Japanese Patent Application Laid-open No. 2003-211770 discloses a method in which a resist for recording paper is adjusted for each printing page. In the conventional method, a mark for adjustment is written on the recording paper and the mark is read to carry out adjustment of a print recording timing. Japanese Patent Application Laid-open No. H11-308443 and Japanese Patent No. 3492071, for example, disclose methods in which a pre-adjustment is performed and the adjusted value is used later.

However, the manual resist adjustment mentioned earlier is based on the assumption that paper is always fed to the same position. As shown in FIG. 15, if the fed paper is misaligned, printing cannot be performed at the same position, and quality of an image is affected due to misalignment of the fed paper even if the resist adjustment is performed accurately.

Although the conventional method disclosed in Japanese Patent Application Laid-open No. 2003-211770 can be easily implemented in a large-scale image forming apparatus, it is difficult to implement the method in a compact image forming apparatus without causing a significant reduction in the productivity. In the case of the conventional methods disclosed in Japanese Patent Application Laid-open No. H11-308443 and Japanese Patent No. 3492071, if an image forming apparatus includes a long feed path for recording paper, an extremely high-precision feeding mechanism is necessary.

### SUMMARY OF THE INVENTION

It is an object of the present invention to at least partially solve the problems in the conventional technology.

According to an aspect of the present invention, an image forming apparatus includes a printing unit, a detecting unit that is arranged on the printing unit to detect a tip and an edge of a recording medium, and issues a detection signal based on which the printing unit moves in a main scanning direction and the recording medium moves in a sub-scanning direction at predetermined timing to form an image on the recording medium, and an adjusting unit that moves, after the detecting unit has detected the tip of the recording medium before printing, the printing unit in the main scanning direction until the detecting unit detects at least one edge of the recording medium to specify position of the recording medium, and adjusts, based on specified position, an image forming position on the recording medium where the image is to be formed.

According to another aspect of the present invention, an image forming apparatus includes a printing unit, a detecting unit that is arranged on the printing unit to detect a tip and an edge of a recording medium, and issues a detection signal based on which the printing unit moves in a main scanning direction and the recording medium moves in a sub-scanning direction at predetermined timing to form an image on the recording medium, and an adjusting unit that causes, after the detecting unit has detected the tip of the recording medium before printing, the detecting unit to detect an edge of the recording medium on a home position side of the printing unit to specify position of the recording medium, and adjusts, based on specified position, a image forming position on the recording medium where the image is to be formed.

According to still another aspect of the present invention, a resist adjusting method applied to an image forming apparatus that includes a printing unit, and a detecting unit that is arranged on the printing unit to detect a tip and an edge of a recording medium and issues a detection signal based on which the printing unit moves in a main scanning direction and the recording medium moves in a sub-scanning direction at predetermined timing to form an image on the recording medium, includes first detecting a tip of a recording medium to specify an image forming position on the recording medium where an image is to be formed, second detecting at least one edge of the recording medium, specifying position of the recording medium based on detected edge, and adjusting the image forming position based on specified position.

According to still another aspect of the present invention, a resist adjusting method applied to an image forming apparatus that includes a printing unit, and a detecting unit that is arranged on the printing unit to detect a tip and an edge of a recording medium and issues a detection signal based on which the printing unit moves in a main scanning direction and the recording medium moves in a sub-scanning direction at predetermined timing to form an image on the recording medium, includes first detecting a tip of a recording medium to specify an image forming position on the recording medium where an image is to be formed, second detecting an edge of the recording medium on a home position side of the printing unit, specifying position of the recording medium based on detected edge, and adjusting the image forming position based on specified position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image forming apparatus according to an embodiment of the present invention;

FIG. 2 is a schematic for explaining an example of specifying a position of paper in a main scanning direction by detecting edges on both sides of the paper in the image forming apparatus;

FIG. 3 is a schematic for explaining an example of specifying the position of paper in the main scanning direction by detecting an edge on one side of the paper in the image forming apparatus;

FIG. 4 is a flowchart of a first example of operation of the image forming apparatus;

FIG. 5 is a flowchart of a second example of operation of the image forming apparatus;

FIG. 6 is a flowchart of a third example of operation of the image forming apparatus;

FIG. 7 is a flowchart of a fourth example of operation of the image forming apparatus;

FIG. 8 is a flowchart of a fifth example of operation of the image forming apparatus;

FIG. 9 is an example of a setting screen for resist adjustment during printing in the image forming apparatus;

FIG. 10 is a flowchart of a sixth example of operation of the image forming apparatus;

FIG. 11 is a flowchart of a seventh example of operation of the image forming apparatus;

FIG. 12 is a flowchart of an eighth example of operation of the image forming apparatus;

FIG. 13 is an example of settings for a printer driver of the image forming apparatus;

FIG. 14 is a flowchart of a ninth example of operation of the image forming apparatus;

FIG. 15 is a schematic for explaining an example in which printing is not started from an appropriate position due to misalignment of fed paper; and

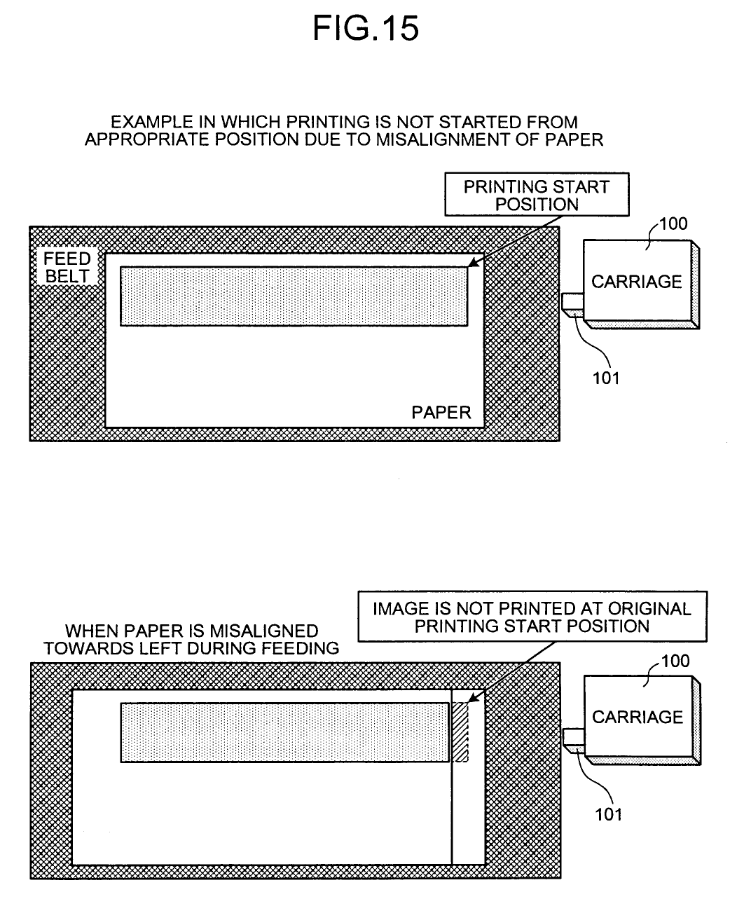

FIG. 16 is a schematic for explaining an example in which a position of skewed paper in the main scanning direction cannot be specified.

### DETAILED DESCRIPTION OF THE PREFERRED EMBODIMENTS

Exemplary embodiments of according to the present invention are explained in detail below with reference to the accompanying drawings.

The present invention can be implemented regardless of the size of an image forming apparatus. According to an embodiment of the present invention, adjustment for each page can be performed if necessary, and an image forming apparatus does not require such a high-precision feeding mechanism as mentioned earlier.

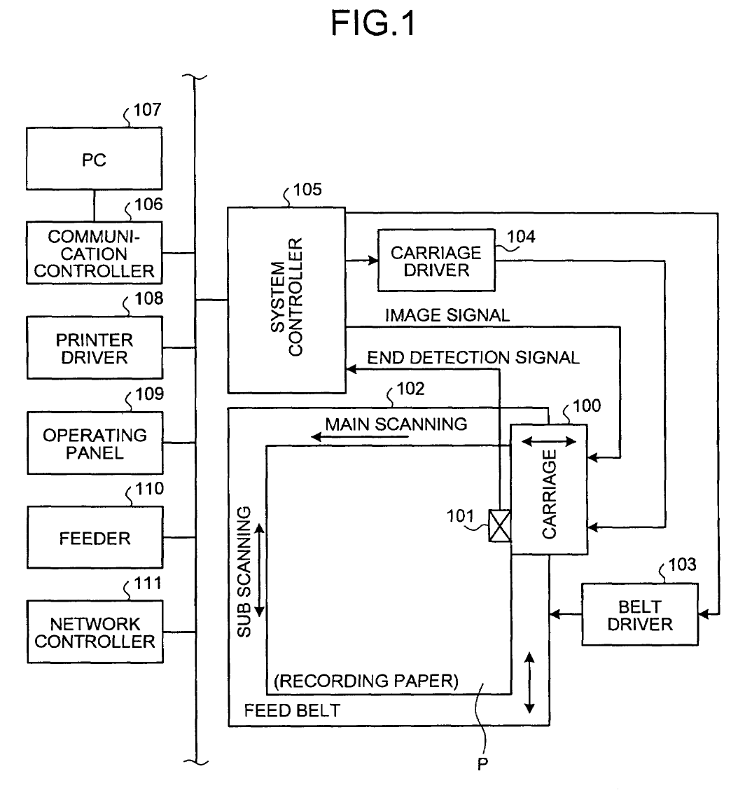

FIG. 1 is a functional block diagram of an image forming apparatus according to an embodiment of the present invention. The image forming apparatus includes a carriage 100, an optical sensor 101, a feed belt 102, a belt driver 103, a carriage driver 104, a system controller 105, a communication controller 106, a personal computer (PC) 107, a printer driver 108, an operating panel 109, a feeder 110, and a network controller 111. The carriage 100 includes an ink nozzle for each color and moves in a main scanning direction. The optical sensor 101 is arranged on the carriage 100 and detects an edge of a recording medium or paper P. The feed belt 102 feeds the recording paper P. The belt driver 103 drives the feed belt 102. The carriage driver 104 drives the carriage 100. The system controller 105 controls the entire image forming apparatus. The feeder 110 houses the recording paper P in a tray and feeds the recording paper P. The feeder 110 includes a size detecting mechanism that uses a size detecting method generally used in a copier etc. to detect the size of the recording paper P.

As just described, the image forming apparatus according to the embodiment is an inkjet recording device. In the image forming apparatus, the carriage 100 maintains for each color, a head that includes the ink-discharging nozzle arranged in a sub-scanning direction. The carriage 100 is alternatively moved (scanned) in a main scanning direction and in the sub-scanning direction of the paper (recording paper P) to form an image. The optical sensor 101 fixed to the carriage 100 can detect the edge of the paper.

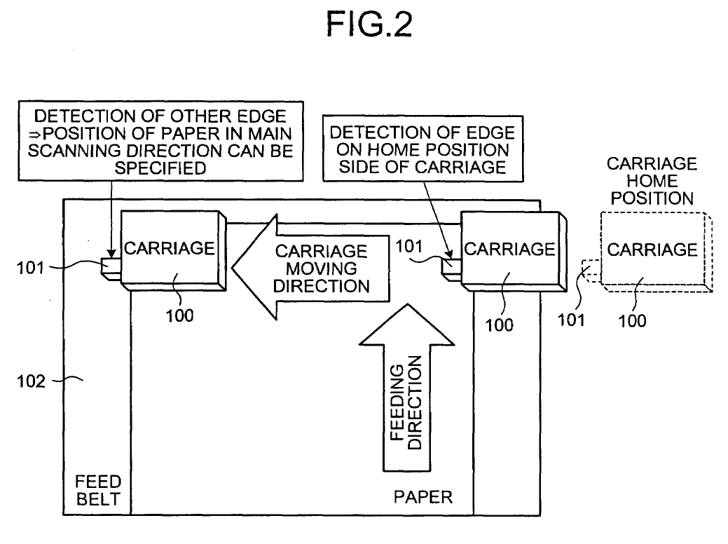

As shown in FIG. 2, to start printing, the image forming apparatus detects a tip of paper. Next, the image forming apparatus continues scanning until edges on both sides of the paper are detected, and specifies a position of the paper in the main scanning direction. A printing start position of the image is adjusted according to the specified position of the paper in the main scanning direction. Such an operation at the time of printing start enables printing from an appropriate position even if the position of fed paper varies each time paper is fed.

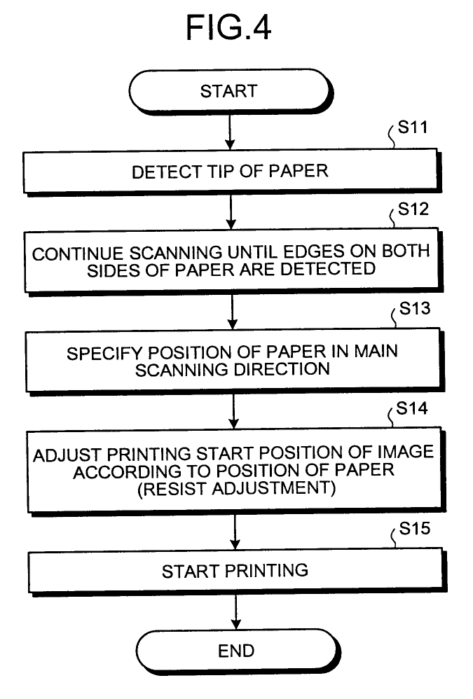

FIG. 4 is a flowchart of a first example of operation of the image forming apparatus. The system controller 105 controls the operation. Upon start of the operation, the carriage 100 that is at a home position moves in the main scanning direction, and detects a tip of paper (step S11). Next, the carriage 100 detects the edge of the paper on the home position side, and continues scanning until the edge on the other side is detected (step S12). By detecting both the edges of the paper, the carriage 100 specifies the position of the paper in the main scanning direction (step S13). Next, the carriage 100 adjusts the printing start position of the image, in other words, performs a resist adjustment according to the position of the paper (step S14), and starts printing (step S15).

Due to this, the printing start position is appropriately adjusted according to the position of fed paper, and printing can be performed from the accurate printing start position. Thus, positional accuracy of resist on the paper is ensured at the appropriate position and printing position accuracy is enhanced.

In a second example of operation that is explained next, based on detection of the edge on one side of paper and a paper size, the position of paper in the main scanning direction is specified. That is, a mode of detecting edges on both sides of paper and a mode of detecting an edge on one side of paper are switched to specify the position of paper in the main scanning direction.

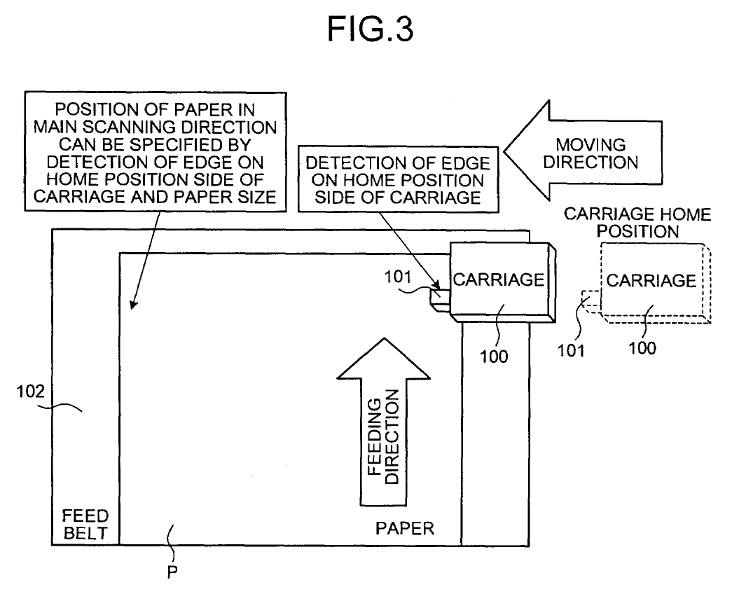

For the resist adjustment at the time of printing, after detection of a tip of paper, scanning is performed to specify the position of the paper in the main scanning direction. If the mode of detecting edges on both sides of paper is set to specify the position of the paper in the main scanning direction, as in the first example of operation mentioned earlier, the carriage 100 is used to carry out scanning until the edges on both sides of the paper are detected. If the mode of detecting an edge on one side of paper is set to specify the position of the paper in the main scanning direction, the scanning ends when the edge on one side of the paper is detected, and the position of the other edge of the paper is calculated from the position of the detected edge and the paper size (the paper size is obtained from the feeder 110). Thus, the position of the paper in the main scanning direction can be specified (see FIG. 3). After specifying the position of the paper in the main scanning direction, the printing start position of the image is adjusted to the appropriate position to start printing.

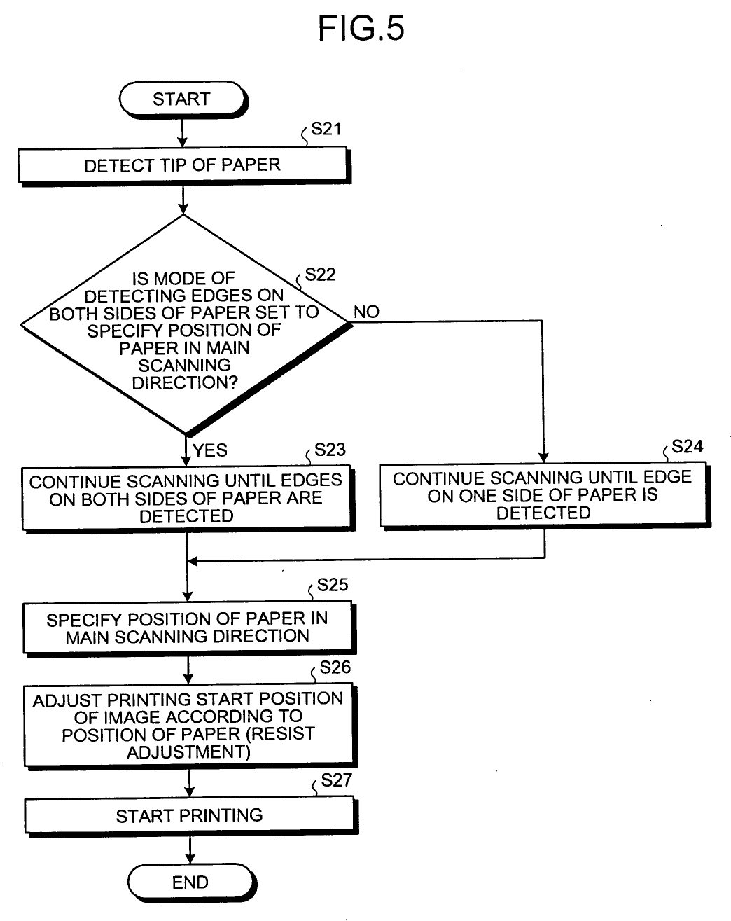

FIG. 5 is a flowchart of the second example of operation of the image forming apparatus. The system controller 105 controls the operation. Upon start of the operation, the carriage 100 that is at the home position moves in the main scanning direction, and detects a tip of paper (step S21). Next, the carriage 100 determines whether the mode of detecting edges on both sides of paper is set to specify the position of the paper in the main scanning direction (step S22). If the mode of detecting edges on both sides of paper is set, the carriage 100 continues scanning until the edges on both sides of the paper are detected (step S23). If the mode of detecting edges on both sides of paper is not set, as shown in FIG. 3, the carriage 100 detects the edge of the paper on the home position side and continues scanning until the edge on the other side is detected (step S24). After the process at step S23 or step S24, the carriage 100 specifies the position of the paper in the main scanning direction (step S25). Next, according to the specified position of the paper, the carriage 100 adjusts the printing start position of the image, in other words, performs the resist adjustment (step S26), and starts printing (step S27).

Thus, if the mode of detecting an edge on one side of paper is set to specify the position of the paper in the main scanning direction, a scanning distance for specifying the position of the paper in the main scanning direction is restricted to the minimum. Accordingly, reduction in the productivity due to the resist adjustment at the time of printing can be restricted to the minimum.

In a third example of operation that is explained next, according to a feeder tray used at the time of printing, the mode of detecting edges on both sides of paper or the mode of detecting an edge on one side of paper are selectively switched to specify the position of paper in the main scanning direction.

For the resist adjustment at the time of printing, after a tip of the paper is detected, scanning is performed to specify the position of paper in the main scanning direction. If the paper is fed from the tray that holds paper of an irregular size, the mode of detecting edges on both sides of paper is used to specify the position of the paper in the main scanning direction. If the paper is fed from the tray that holds paper of a regular size, any one of the mode of detecting edges on both sides of paper or the mode of detecting an edge on one side of paper is used to specify the position of the paper in the main scanning direction. After specifying the position of the paper in the main scanning direction, the printing start position of the image is adjusted to the appropriate position to start printing.

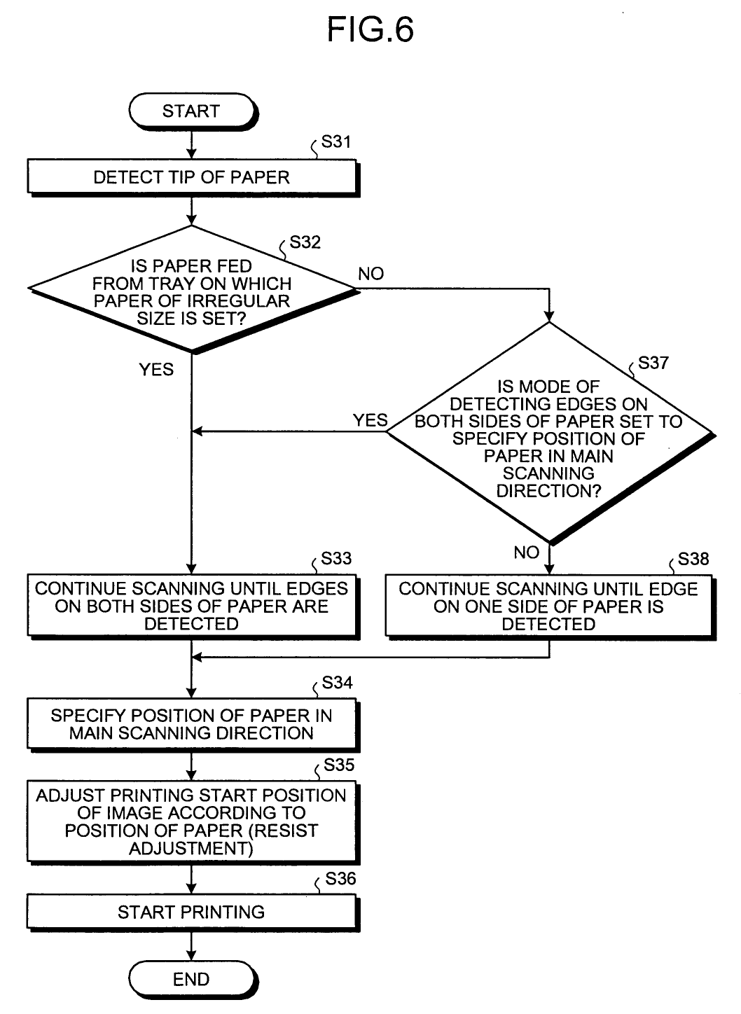

FIG. 6 is a flowchart of the third example of operation of the image forming apparatus. The system controller 105 controls the operation. Upon start of the operation, the carriage 100 that is at the home position moves in the main scanning direction, and detects a tip of paper (step S31). The carriage 100 determines whether the paper is fed from the tray on which paper of an irregular size is set (step S32). If paper of an irregular size is set, the carriage 100 continues scanning until the edge of the paper is detected (step S33), and specifies the position of the paper in the main scanning direction (step S34). The carriage 100 adjusts the printing start position of the image, in other words, performs the resist adjustment according to the position of the paper (step S35), and starts printing (step S36). If paper of an irregular size is not set at step S32, the carriage 100 further determines whether the mode of detecting edges on both sides of paper is set to specify the position of the paper in the main scanning direction (step S37). If the mode of detecting edges on both sides of paper is set, the operation proceeds to step S33. If the mode of detecting edges on both sides of paper is not set, the carriage 100 continues scanning until the edge on one side of the paper is detected (step S38), and the operation proceeds to step S34.

Thus, the position of paper in the main scanning direction can be specified according to the feeder tray at the time of printing. Due to this, the mode of detecting an edge on one side of paper can be selected only for the tray on which paper of an irregular size cannot be set (is not being set). For the tray on which paper of an irregular size can be set (is being set), the accurate position of the paper in the main scanning direction can be specified by compulsorily using the mode of detecting edges on both sides of paper. Thus, the resist adjustment can be performed at the time of printing.

In a fourth example of operation that is explained next, according to the size of paper fed at the time of printing, the mode of detecting edges on both sides of paper or the mode of detecting an edge on one side of paper are selectively switched to specify the position of the paper in the main scanning direction.

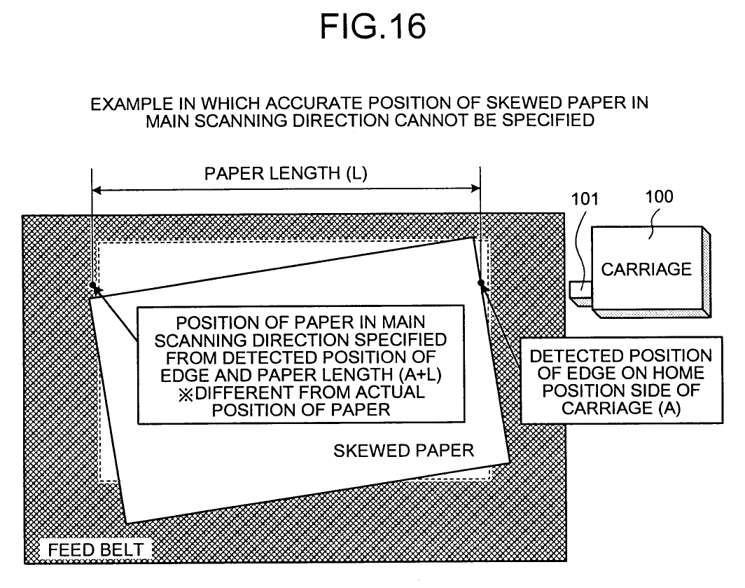

However, as shown in FIG. 16, if the fed paper is skewed, the accurate position of the paper in the main scanning direction cannot be specified by detecting the edge on one side of the paper and the paper size. Due to this, for the resist adjustment at the time of printing, after detection of a tip of the paper, scanning is performed to specify the position of the paper in the main scanning direction. If the size of the fed paper is likely to cause paper skew, the mode of detecting edges on both sides of paper is used to specify the position of the paper in the main scanning direction. If the size of the fed paper is not likely to cause paper skew, any one of the mode of detecting edges on both sides of paper or the mode of detecting an edge on one side of paper is used to specify the position of the paper in the main scanning direction. After specifying the position of the paper in the main scanning direction, the printing start position of the image is adjusted to the appropriate position to start printing.

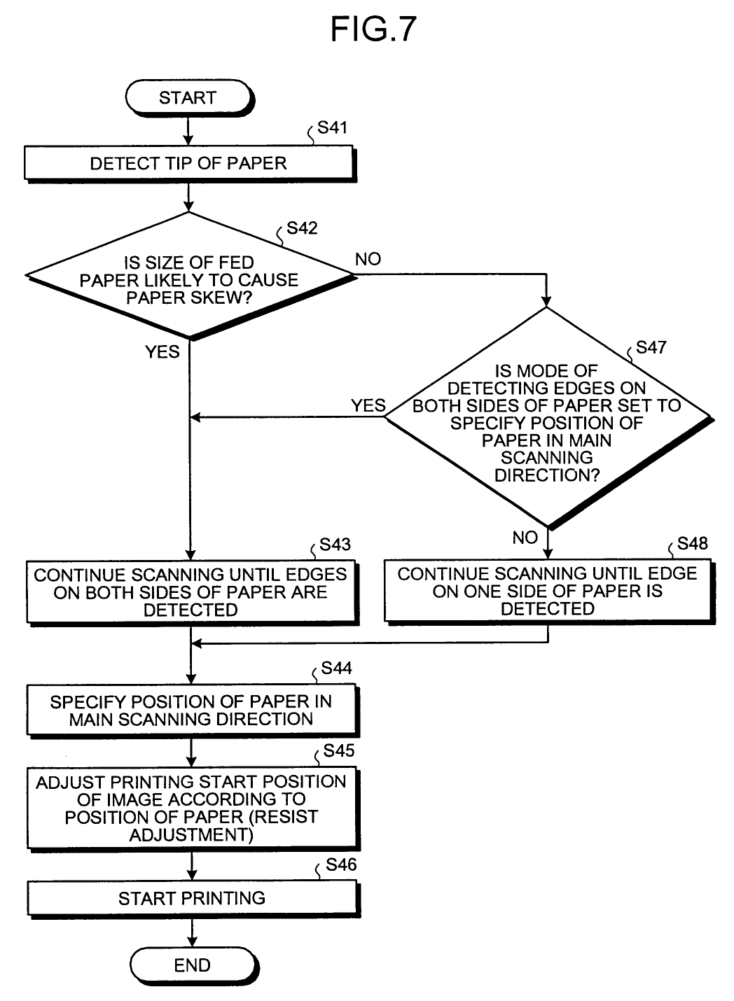

FIG. 7 is a flowchart of the fourth example of operation of the image forming apparatus. The system controller 105 controls the operation. Upon start of the operation, the carriage 100 that is at the home position moves in the main scanning direction, and detects a tip of paper (step S41). The carriage 100 determines whether the size of the fed paper is likely to cause paper skew (step S42). If the size of the fed paper is likely to cause paper skew, the carriage 100 continues scanning until the edges on both sides of the paper are detected (step S43), and specifies the position of the paper in the main scanning direction (step S44). Next, the carriage 100 adjusts the printing start position of the image, in other words, performs the resist adjustment according to the specified position of the paper (step S45), and starts printing (step S46). At step S42, if the size of the fed paper is not likely to cause paper skew, the carriage 100 further determines whether the mode of detecting edges on both sides of paper is set to specify the position of the paper in the main scanning direction (step S47). If the mode of detecting edges on both sides of paper is set, the carriage 100 continues scanning until the edges on both sides of the paper are detected (step S43). If the mode of detecting edges on both sides of paper is not set, the carriage 100 detects the edge on the home position side of the paper and further continues scanning until the edge on the other side is detected (step S48).

Thus, the mode to specify the position of the paper in the main scanning direction can be set according to the size of fed paper at the time of printing. Due to this, even if the size of the fed paper is likely to cause paper skew, by setting the mode of detecting edges on both sides of paper to specify the position of the paper in the main scanning direction, the position of the paper in the main scanning direction can be specified regardless of paper skew, and the resist adjustment at the time of printing is realized.

In a fifth example of operation that is explained next, according to an application (a facsimile, a copier, a printer, etc.) used at the time of printing, the mode of detecting edges on both sides of paper or the mode of detecting an edge on one side of paper are selectively switched to specify the position of paper in the main scanning direction.

For the resist adjustment at the time of printing, after detection of a tip of paper, scanning is performed to specify the position of the paper in the main scanning direction. A mode, which is set in the application that executes printing, is used to specify the position of the paper in the main scanning direction. For example, the mode of detecting edges on both sides of paper is set when the image is output by facsimile. The mode of detecting an edge on one side of paper is set when the image is output by the printer or the copier. During printing from a facsimile application, after detecting the tip of the paper, a system detects the edges on both sides of the paper to specify the position of the paper in the main scanning direction, and performs the resist adjustment to start printing. During printing from the copier or the printer, after detecting the tip of the paper, the system detects the edge on one side of the paper to specify the position of the paper in the main scanning direction, and performs the resist adjustment to start printing.

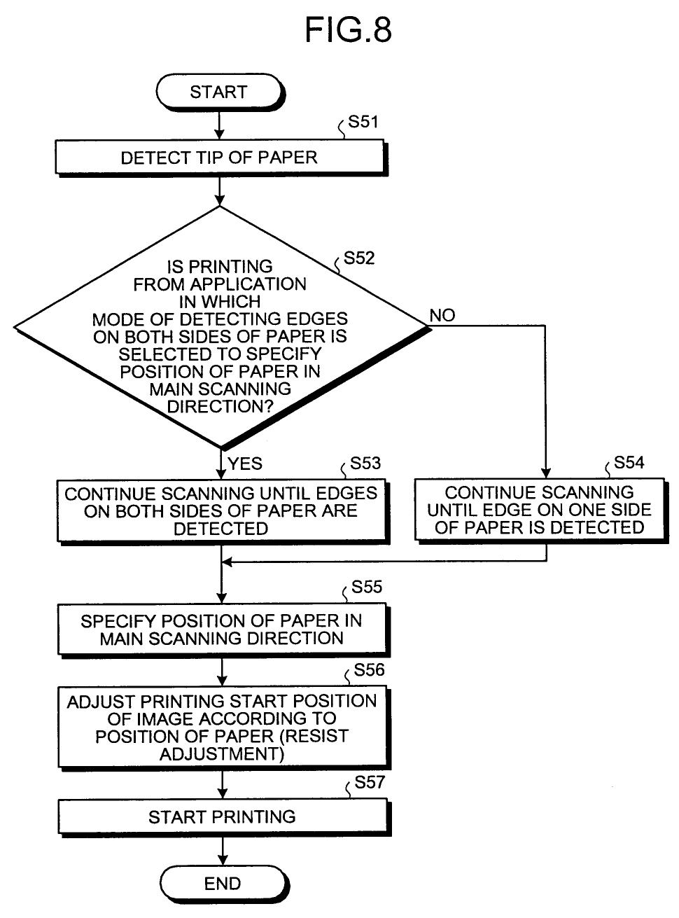

FIG. 8 is a flowchart of the fifth example of operation of the image forming apparatus. The system controller 105 controls the operation. Upon start of the operation, the carriage 100 that is at the home position moves in the main scanning direction, and detects a tip of paper (step S51). Next, the carriage 100 determines whether printing is from an application in which the mode of detecting edges on both sides of paper is selected to specify the position of the paper in the main scanning direction (step S52). If printing is from an application in which the mode of detecting edges on both sides of paper is selected, the carriage 100 continues scanning until the edges on both sides of the paper are detected (step S53) and specifies the position of the paper in the main scanning direction (step S55). Next, according to the specified position of the paper, the carriage 100 adjusts the printing start position of the image, in other words, performs the resist adjustment (step S56), and starts printing (step S57). At step S52, if printing is not from an application in which the mode of detecting edges on both sides of paper is selected, the carriage 100 continues scanning until the edge on one side of the paper is detected (step S54), and the operation proceeds to step S55.

Due to this, the mode to specify the position of paper in the main scanning direction can be set according to the application. For an application without an emphasis on the productivity, the mode of detecting edges on both sides of the paper is used to specify the position of the paper in the main scanning direction. For an application with an emphasis on the productivity, the mode of detecting an edge on one side of paper is used to specify the position of the paper in the main scanning direction.

In a sixth example of operation that is explained next, a selection is made as to whether to perform the resist adjustment at the time of printing.

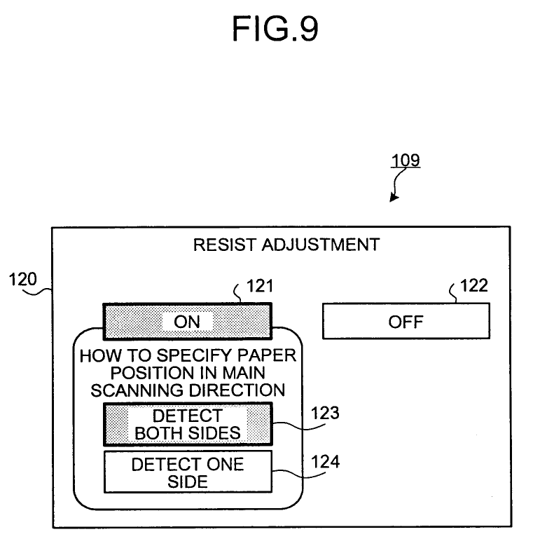

If a user has to output a large number of images received by facsimile, carrying out the resist adjustment at the time of printing reduces the productivity. When outputting the images by facsimile, the user specifies settings to ensure that the resist adjustment is not performed at the time of printing. A selection button can be displayed on a setting screen of the facsimile to switch between performing and not performing the resist adjustment at the time of printing. For example, as shown in FIG. 9, an “ON” button 121 and an “OFF” button 122 are displayed on a “resist adjustment” screen 120. The “ON” button 121 includes a “detect both sides” button 123 and a “detect one side” button 124.

When the resist adjustment is not performed at the time of printing by facsimile, the system performs a commonly used printing operation (directly starts printing immediately after detection of a tip of paper) without performing the resist adjustment. Thus, scanning for specifying the position of the paper in the main scanning direction is not necessary and reduction in the productivity can be prevented.

If prevention of reduction in the image quality is important than reduction in the productivity, the user selects a setting to perform the resist adjustment at the time of printing. The user also sets the mode for specifying the position of the paper in the main scanning direction. Due to this, the system always performs the resist adjustment at the time of printing. Thus, printing is started from the appropriate position and reduction in the image quality can be prevented.

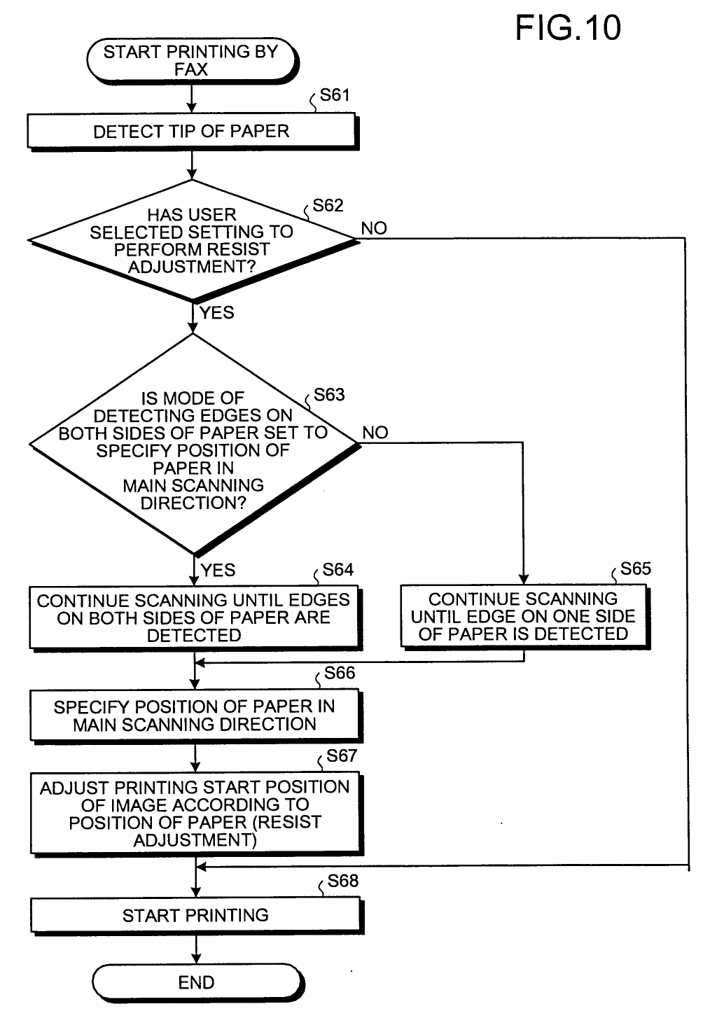

FIG. 10 is a flowchart of the sixth example of operation of the image forming apparatus. The system controller 105 controls the operation. Upon start of the operation, the carriage 100 that is at the home position moves in the main scanning direction, and detects a tip of paper (step S61). If facsimile is used for printing, the carriage 100 determines whether the user has selected the setting to perform the resist adjustment at the time of printing (step S62). In other words, the carriage 100 determines whether the “ON” button 121 shown in FIG. 9 is pressed. If the user has selected the setting to perform the resist adjustment, the carriage 100 further determines whether the user has set the mode of detecting edges on both sides of paper to specify the position of the paper in the main scanning direction (step S63). In other words, the carriage 100 determines whether any one of the “detect both sides” button 123 or the “detect one side” button 124 shown in FIG. 9 is pressed. At step S63, if the user has set the mode of detecting edges on both sides of paper, the carriage 100 continues scanning until the edges on both sides of the paper are detected (step S64). If the user has set the mode of detecting an edge on one side of paper, the carriage 100 continues scanning until the edge on one side of the paper is detected (step S65). Next, the carriage 100 specifies the position of the paper in the main scanning direction (step S66). Next, the carriage 100 adjusts the printing start position of the image, in other words, performs the resist adjustment according to the specified position of the paper (step S67), and starts printing (step S68).

If the resist adjustment is performed each time of printing by facsimile, productivity is reduced. To overcome the drawback, the user inputs the setting to perform the resist adjustment at the time of printing only when printing is performed due to facsimile receipt from a specific partner or when a printing volume is equal to or less than a predetermined volume during an alternate receipt. When printing is performed due to facsimile receipt from the specific partner, the system performs the resist adjustment at the time of printing to print the image, thereby enabling to prevent reduction in the image quality. When printing is performed due to facsimile receipt from users other than the specific partner, the system performs the commonly used printing operation without performing the resist adjustment at the time of printing, thereby enabling to prevent reduction in the productivity.

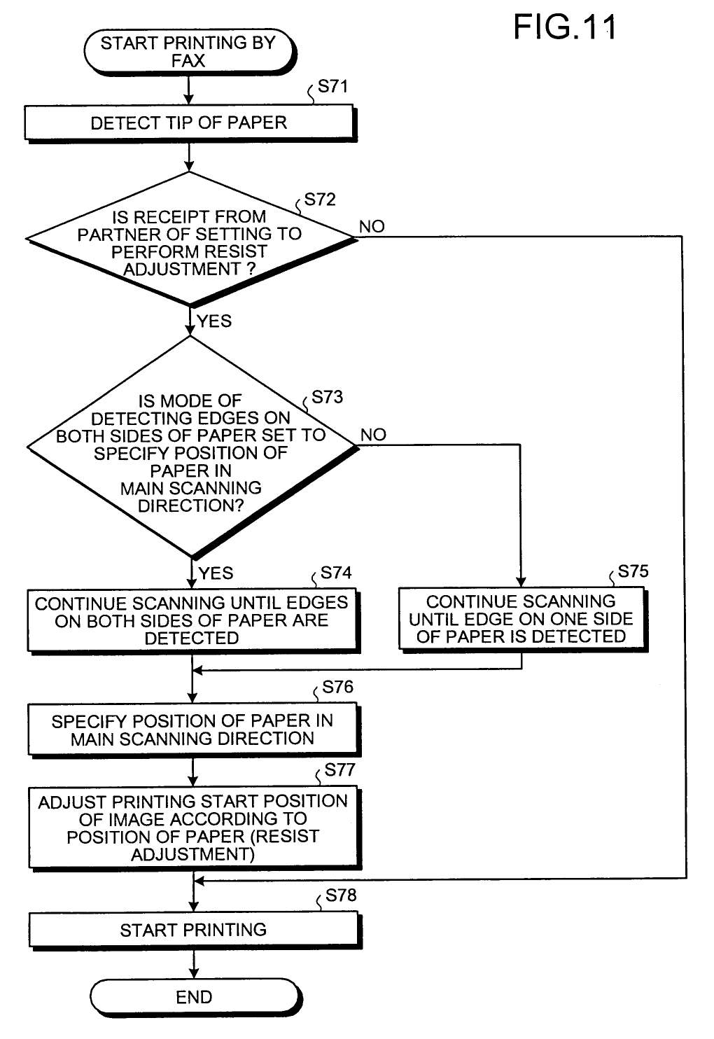

FIG. 11 is a flowchart of a seventh example of operation of the image forming apparatus. The system controller 105 controls the operation. Upon start of the operation, the carriage 100 that is at the home position moves in the main scanning direction, and detects a tip of paper (step S71). Next, the carriage 100 determines whether the receipt is from a partner of the setting to perform the resist adjustment at the time of printing (step S72). If the receipt is from a partner of the setting to perform the resist adjustment at the time of printing, the carriage 100 further determines whether the user has set the mode of detecting edges on both sides of paper to specify the position of the paper in the main scanning direction (step S73). If the user has set the mode of detecting edges on both sides of paper, the carriage 100 continues scanning until the edges on both sides of the paper are detected (step S74). If the user has set the mode of detecting an edge on one side of paper, the carriage 100 continues scanning until the edge on one side of the paper is detected (step S75). Next, the carriage 100 specifies the position of the paper in the main scanning direction (step S76). Next, the carriage 100 adjusts the printing start position of the image, in other words, performs the resist adjustment according to the specified position of the paper (step S77), and starts printing (step S78).

In an eighth example of operation that is explained next, a selection is made as to whether to perform the resist adjustment at the time of printing.

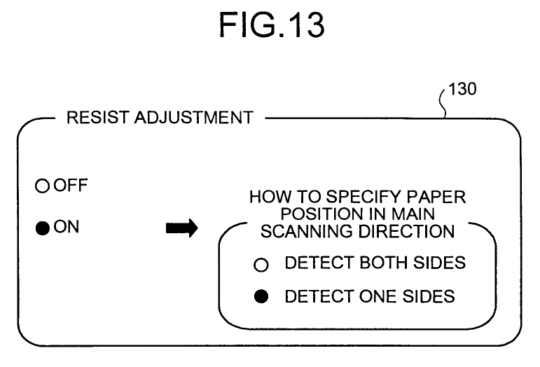

If a large amount of copying is necessary, the resist adjustment at the time of printing reduces the productivity. Due to this, when carrying out copying, the user inputs the setting to ensure that the resist adjustment is not performed at the time of printing. A selection button can be displayed on a setting screen of the copier to switch between performing and not performing the resist adjustment at the time of printing (see FIG. 13). As shown in FIG. 13, a “resist adjustment” screen 130 is provided to a printer driver.

When the resist adjustment is not performed at the time of printing by the copier, the system performs the commonly used printing operation (directly starts printing immediately after detection of a tip of paper) without carrying out the resist adjustment. Thus, scanning for specifying the position of the paper in the main scanning direction is not necessary and reduction in the productivity can be prevented. If prevention of reduction in the image quality is important than reduction in the productivity, the user selects the setting to perform the resist adjustment at the time of printing. The user also sets the mode for specifying the position of the paper in the main scanning direction. Due to this, the system always performs the resist adjustment at the time of printing. Thus, printing is started from the appropriate position and reduction in the image quality can be prevented. Even if the user has started a large amount of copying with the setting to perform the resist adjustment at the time of printing, stopping the resist adjustment in process may be necessary. To cope with such a situation, the setting can be switched in process of copying.

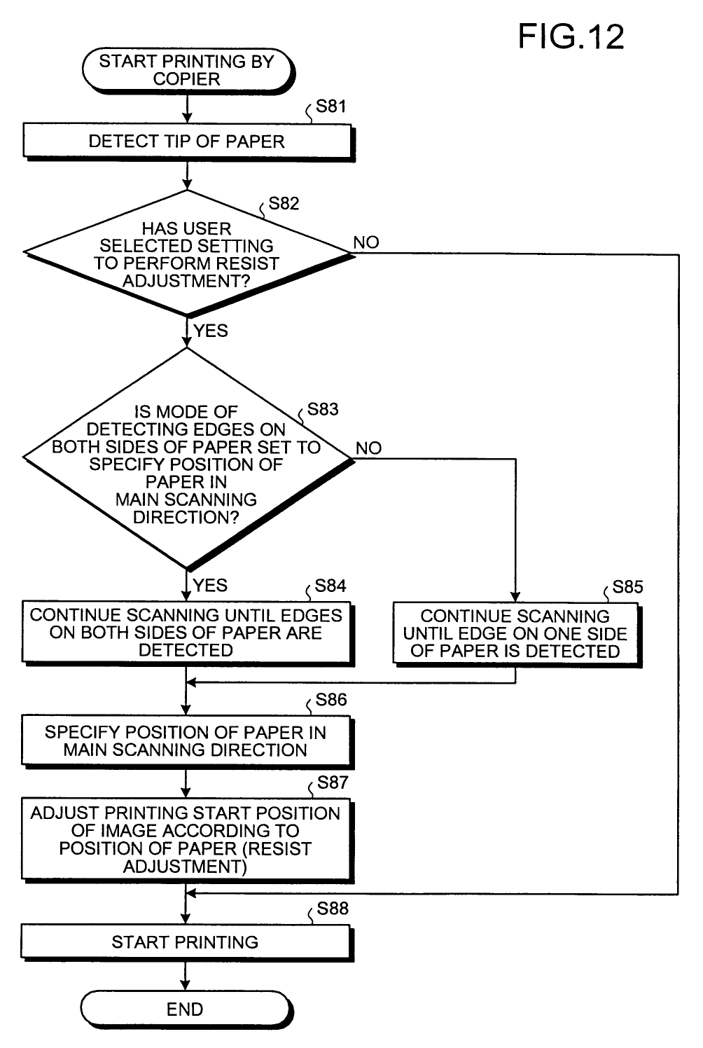

FIG. 12 is a flowchart of the eighth example of operation of the image forming apparatus. The system controller 105 controls the operation. Upon start of the operation, the carriage 100 that is at the home position moves in the main scanning direction, and detects a tip of paper (step S81). Next, if the copier is used for printing, the carriage 100 determines whether the user has selected the setting to perform the resist adjustment at the time of printing (step S82). If the user has selected the setting to perform the resist adjustment at the time of printing, the carriage 100 further determines whether the user has set the mode of detecting edges on both sides of paper to specify the position of the paper in the main scanning direction (step S83). If the user has set the mode of detecting edges on both sides of paper, the carriage 100 continues scanning until the edges on both sides of the paper are detected (step S84). If the user has set the mode of detecting an edge on one side of paper, the carriage 100 continues scanning until the edge on one side of the paper is detected (step S85). Next, the carriage 100 specifies the position of the paper in the main scanning direction (step S86). Next, the carriage 100 adjusts the printing start position of the image, in other words, performs the resist adjustment according to the specified position of the paper (step S87), and starts printing (step S88). At step S82, if the user has not selected the setting to perform the resist adjustment at the time of printing, the operation proceeds to step S88.

In a ninth example of operation that is explained next, a selection is made as to whether to perform the resist adjustment at the time of printing.

The image forming apparatus notifies a data transmission source that the image forming apparatus has a function to perform the resist adjustment at the time of printing and a function to switch between performing and not performing the resist adjustment at the time of printing. Due to this, the user who is the data transmission source can cause the system that is a data transmission destination to recognize the function to perform the resist adjustment at the time of printing and the function to switch between performing and not performing the resist adjustment at the time of printing. Thus, when transmitting data, the user can determine whether to perform the resist adjustment at the time of printing (see FIG. 13).

If the user has to use the image forming apparatus as the printer and a large amount of printing is required, the resist adjustment at the time of printing reduces the productivity. To overcome the drawback, the user inputs the setting to ensure that the resist adjustment is not performed during a large amount of printing and transmits the data. Thus, the commonly used printing operation is performed without the resist adjustment at the time of printing, and reduction in the productivity can be prevented.

If preventing reduction in the image quality is important than reduction in the productivity, the user selects the setting to perform the resist adjustment at the time of printing, sets the mode for specifying the position of the paper in the main scanning direction, and transmits the data. Due to this, because the system always performs the resist adjustment at the time of printing, printing is started from the appropriate position and the reduction in the image quality can be prevented. When using the image forming apparatus as the printer, even if the user has started a large amount of printing with the setting to perform the resist adjustment at the time of printing, stopping the resist adjustment in process may be necessary. To cope with such a situation, the setting can be switched in process of printing.

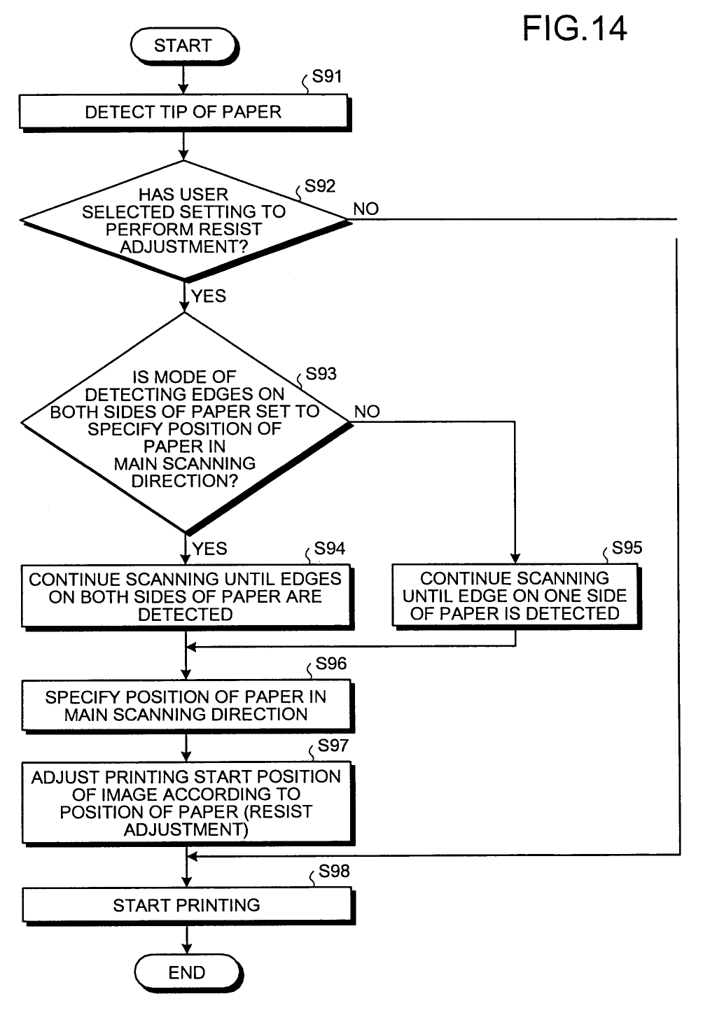

FIG. 14 is a flowchart of the ninth example of operation of the image forming apparatus. The system controller 105 controls the operation. Upon start of the operation, the carriage 100 that is at the home position moves in the main scanning direction, and detects a tip of paper (step S91). Next, the carriage 100 determines whether the user has selected the setting to perform the resist adjustment at the time of printing (step S92). If the user has selected the setting to perform the resist adjustment at the time of printing, the carriage 100 further determines whether the user has set the mode of detecting edges on both sides of paper to specify the position of the paper in the main scanning direction (step S93). If the user has set the mode of detecting edges on both sides of paper, the carriage 100 continues scanning until the edges on both sides of the paper are detected (step S94). If the user has set the mode of detecting an edge on one side of paper, the carriage 100 continues scanning until the edge on one side of the paper is detected (step S95). Next, the carriage 100 specifies the position of the paper in the main scanning direction (step S96). The carriage 100 adjusts the printing start position of the image, in other words, performs the resist adjustment according to the specified position of the paper (step S97), and starts printing (step S98). At step S92, if the user has not selected the setting to perform the resist adjustment at the time of printing, the operation proceeds to step S98.

As set forth hereinabove, according to an embodiment of the present invention, an image forming position can be adjusted based on the position of a recording medium, the size of the recording medium, the type of an application, or an output format for facsimile receipt. Therefore, resist adjustment can be performed with a simple structure. Thus, an image is formed at a predetermined position and stable image quality can be achieved.

Moreover, a scanning distance in the main scanning direction is restricted to the minimum. Thus, reduction in the productivity due to the resist adjustment at the time of printing can be restricted to the minimum.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a printing unit;
a detecting unit that is arranged on the printing unit to detect a tip and an edge of a recording medium, and issues a detection signal based on which the printing unit moves in a main scanning direction and the recording medium moves in a sub-scanning direction at predetermined timing to form an image on the recording medium; and
an adjusting unit that moves, after the detecting unit has detected the tip of the recording medium before printing, the printing unit in the main scanning direction until the detecting unit detects at least one edge of the recording medium to specify position of the recording medium, and adjusts, based on specified position, an image forming position on the recording medium where the image is to be formed.

2. The image forming apparatus according to claim 1, wherein the adjusting unit causes the detecting unit to detect any one of edges on both sides and an edge on one side of the recording medium according to a size of the recording medium to the specify the position of the recording medium, and adjusts the image forming position based on specified position.

3. The image forming apparatus according to claim 1, wherein the adjusting unit causes the detecting unit to detect any one of edges on both sides and an edge on one side of the recording medium according to a type of an application including a copier, a printer, and a facsimile to specify the position of the recording medium, and adjusts the image forming position based on specified position.

4. The image forming apparatus according to claim 1, further comprising a selecting unit that selects whether to adjust the image forming position, and outputs selection information, wherein
the adjusting unit determines whether to adjust the image forming position based on the selection information.

5. An image forming apparatus comprising:
a printing unit;
a detecting unit that is arranged on the printing unit to detect a tip and an edge of a recording medium, and issues a detection signal based on which the printing unit moves in a main scanning direction and the recording medium moves in a sub-scanning direction at predetermined timing to form an image on the recording medium; and
an adjusting unit that causes, after the detecting unit has detected the tip of the recording medium before printing, the detecting unit to detect an edge of the recording medium on a home position side of the printing unit to specify position of the recording medium, and adjusts, based on specified position, a image forming position on the recording medium where the image is to be formed.

6. The image forming apparatus according to claim 5, wherein the adjusting unit causes the detecting unit to detect any one of edges on both sides and an edge on one side of the recording medium according to a size of the recording medium to specify the position of the recording medium, and adjusts the image forming position based on specified position.

7. The image forming apparatus according to claim 5, wherein the adjusting unit causes the detecting unit to detect any one of edges on both sides and an edge on one side of the recording medium according to a type of an application including a copier, a printer, and a facsimile to specify the position of the recording medium, and adjusts the image forming position based on specified position.

8. The image forming apparatus according to claim 5, further comprising a selecting unit that selects whether to adjust the image forming position, and outputs selection information, wherein
the adjusting unit determines whether to adjust the image forming position based on the selection information.

9. A resist adjusting method applied to an image forming apparatus that includes a printing unit, and a detecting unit that is arranged on the printing unit to detect a tip and an edge of a recording medium and issues a detection signal based on which the printing unit moves in a main scanning direction and the recording medium moves in a sub-scanning direction at predetermined timing to form an image on the recording medium, the resist adjusting method comprising:
first detecting a tip of a recording medium to specify an image forming position on the recording medium where an image is to be formed;
second detecting at least one edge of the recording medium;
specifying position of the recording medium based on detected edge; and
adjusting the image forming position based on specified position.

10. The resist adjusting method according to claim 9, wherein the second detecting includes detecting any one of edges on both sides and an edge on one side of the recording medium according to a size of the recording medium.

11. The resist adjusting method according to claim 9, wherein the second detecting includes detecting any one of edges on both sides and an edge on one side of the recording medium according to a type of an application including a copier, a printer, and a facsimile.

12. The resist adjusting method according to claim 9, wherein the adjusting includes determining whether to adjust the image forming position based on selection information provided from outside.
